(19) United States
(12) Patent Application Publication
(10) Pub. No.: US 2025/0088470 A1
(43) Pub. Date: Mar. 13, 2025

(54) SYSTEM AND METHOD FOR TRACKING MULTIPLE RESOURCE TYPES USING A UNIQUE IDENTIFIER

(71) Applicant: The Toronto-Dominion Bank, Toronto (CA)

(72) Inventors: Mohamedhussein HASSANALI, Vaughan (CA); Romy MOGHAIZEL, Richmond Hill (CA); Kevin Ka-Win YUEN, Toronto (CA); Chloe Lillian Nadia O'SULLIVAN, Markham (CA); Mohamed ELDISHNAWY, Richmond Hill (CA)

(73) Assignee: The Toronto-Dominion Bank, Toronto (CA)

(21) Appl. No.: 18/462,490

(22) Filed: Sep. 7, 2023

(51) Int. Cl. H04L 47/70; H04L 47/76

(52) U.S. Cl. CPC H04L 47/828; G06Q 20/227; G06Q 40/03; H04L 47/76; G06Q 20/381

(57) ABSTRACT

A server computer system, comprises a communications module; at least one processor coupled with the communications module; and a memory coupled to the processor, the memory storing processor-executable instructions that, when executed, configure the at least one processor to configure a unique identifier to be associated with at least a first data record tracking a first resource type and a second data record tracking a second resource type; receive, via the communications module, a first computer-readable message that includes the unique identifier and a request to transfer a first amount of resources; analyze the first computer-readable message to identify a code indicating the first resource type; and complete the transfer of the first amount of resources and update the first data record to include the first amount of resources transferred.

### TECHNICAL FIELD

The present application relates to systems and methods for tracking multiple resource types using a unique identifier.

### BACKGROUND

The transfer of resources such as for example computer resources may be tracked using a data record. It is often difficult to track the usage of multiple resource types.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a simplified schematic diagram showing components of a computing device;

FIG. 3 is a high-level schematic diagram of an example computer device;

FIG. 4 shows a simplified organization of software components stored in a memory of the example computer device of FIG. 3;

FIG. 5 is a flowchart showing operations performed by a server computer system in configuring a unique identifier according to an embodiment;

FIG. 6 is a flowchart showing operations performed by a server computer system in for tracking multiple resource types using the unique identifier according to an embodiment;

FIG. 7 is an example computer-readable message according to an embodiment; and

FIG. 8 is a flowchart showing operations performed by a server computer system in automatically applying a transfer of resources according to an embodiment.

Like reference numerals are used in the drawings to denote like elements and features.

### DETAILED DESCRIPTION OF VARIOUS EMBODIMENTS

Accordingly, in one aspect there is provided a server computer system, comprising a communications module; at least one processor coupled with the communications module; and a memory coupled to the processor, the memory storing processor-executable instructions that, when executed, configure the at least one processor to configure a unique identifier to be associated with at least a first data record tracking a first resource type and a second data record tracking a second resource type; receive, via the communications module, a first computer-readable message that includes the unique identifier and a request to transfer a first amount of resources; analyze the first computer-readable message to identify a code indicating the first resource type; and complete the transfer of the first amount of resources and update the first data record to include the first amount of resources transferred.

In one or more embodiments, the instructions, when executed, further configure the at least one processor to receive, via the communications module, a second computer-readable message that includes the unique identifier and a request to transfer a second amount of resources; analyze the second computer-readable message to identify a code indicating the second resource type; and complete the transfer of the second amount of resources and update the second data record to include the second amount of resources transferred.

In one or more embodiments, the instructions, when executed, further configure the at least one processor to receive, via the communications module, a third computer-readable message that includes the unique identifier and a request to transfer a third amount of resources; analyze the third computer-readable message to identify a code indicating a third resource type; convert the third amount of resources from the third resource type to a fourth amount of the first resource type; and complete the transfer of the third amount of resources and update the first data record to include the fourth amount of the first resource type.

In one or more embodiments, the instructions, when executed, further configure the at least one processor to receive, via the communications module, a request to configure the unique identifier.

In one or more embodiments, the instructions, when executed, further configure the at least one processor to prior to configuring the unique identifier, determine that the request satisfies criteria.

In one or more embodiments, the criteria requires a third data record storing the first resource type and a fourth data record storing the second resource type.

In one or more embodiments, the unique identifier is associated with a same user as the third data record and the fourth data record.

In one or more embodiments, the unique identifier includes a primary account number.

In one or more embodiments, the instructions, when executed, further configure the at least one processor to determine a trigger condition; and responsive to determining the trigger condition, generate a statement that includes an amount of the first resource type indicated by the first data record and an amount of the second resource type indicated by the second data record.

In one or more embodiments, the instructions, when executed, further configure the at least one processor to receive a transfer of resources; determine that a type of the resources transferred includes the first resource type; and update the first data record based on the transfer of resources.

According to another aspect, there is provided a computer-implemented method comprising configuring a unique identifier to be associated with at least a first data record tracking a first resource type and a second data record tracking a second resource type; receiving a first computer-readable message that includes the unique identifier and a request to transfer a first amount of resources; analyzing the first computer-readable message to identify a code indicating the first resource type; and completing the transfer of the first amount of resources and updating the first data record to include the first amount of resources transferred.

In one or more embodiments, the method further comprises receiving a second computer-readable message that includes the unique identifier and a request to transfer a second amount of resources; analyzing the second computer-readable message to identify a code indicating the second resource type; and completing the transfer of the second amount of resources and updating the second data record to include the second amount of resources transferred.

In one or more embodiments, the method further comprises receiving a third computer-readable message that includes the unique identifier and a request to transfer a third amount of resources; analyzing the third computer-readable message to identify a code indicating a third resource type; converting the third amount of resources from the third resource type to a fourth amount of the first resource type; and completing the transfer of the third amount of resources and updating the first data record to include the fourth amount of the first resource type.

In one or more embodiments, the method further comprises receiving a request to configure the unique identifier.

In one or more embodiments, the method further comprises prior to configuring the unique identifier, determining that the request satisfies criteria.

In one or more embodiments, the criteria requires a third data record storing the first resource type and a fourth data record storing the second resource type.

In one or more embodiments, the unique identifier is associated with a same user as the third data record and the fourth data record.

In one or more embodiments, the unique identifier includes a primary account number.

In one or more embodiments, the method further comprises determining a trigger condition; and responsive to determining the trigger condition, generating a statement that includes an amount of the first resource type indicated by the first data record and an amount of the second resource type indicated by the second data record.

According to another aspect there is provided at least one non-transitory computer readable storage medium comprising processor-executable instructions which, when executed, configure at least one processor to configure a unique identifier to be associated with at least a first data record tracking a first resource type and a second data record tracking a second resource type; receive a first computer-readable message that includes the unique identifier and a request to transfer a first amount of resources; analyze the first computer-readable message to identify a code indicating the first resource type; and complete the transfer of the first amount of resources and update the first data record to include the first amount of resources transferred.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

In the present application, various functionalities discussed herein may be performed by a single processor or by any one of one or more processors, either alone or in combination.

In one aspect of the present application, methods and systems are described for tracking multiple resource types using a unique identifier.

In one or more embodiments, a unique identifier is configured to be associated with a first data record tracking a first resource type and a second data record tracking a second resource type. Requests may be received for transferring resources. The requests may include the unique identifier and may be analyzed to identify a code indicating a resource type for the transfer. The transfers may be completed and the appropriate data records may be updated to track the transferred resources. Conveniently, a single unique identifier is used to automatically complete transfers for different resource types and the relevant data record is automatically updated to track the resource type being transferred.

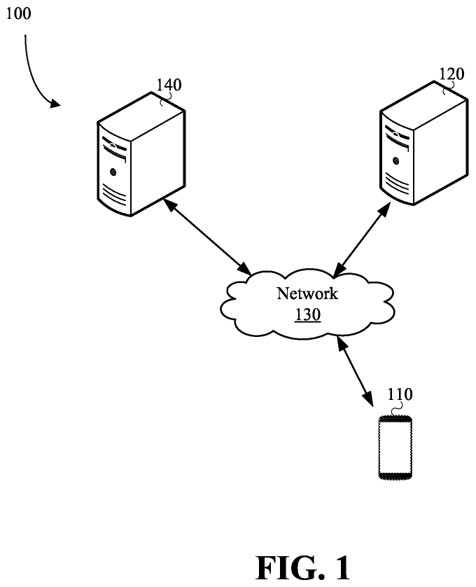

FIG. 1 is a schematic operation diagram illustrating an operating environment of an example embodiment. As shown, the system 100 includes a client device 110 and a server computer system 120 coupled to one another through a network 130, which may include a public network such as the Internet and/or a private network. The client device 110 and the server computer system 120 may be in geographically disparate locations. Put differently, the client device 110 and the server computer system 120 may be located remote from one another.

The client device 110 may be a smartphone as shown in FIG. 1. However, the client device 110 may be a computing device of another type such as for example a laptop computer, a personal computer, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments.

The server computer system 120 is a computer server system. A computer server system may, for example, be a mainframe computer, a minicomputer, or the like. In some implementations thereof, a computer server system may be formed of or may include one or more computing devices. A computer server system may include and/or may communicate with multiple computing devices such as, for example, database servers, computer servers, and the like. Multiple computing devices such as these may be in communication using a computer network and may communicate to act in cooperation as a computer server system. For example, such computing devices may communicate using a local-area network (LAN). In some embodiments, a computer server system may include multiple computing devices organized in a tiered arrangement. For example, a computer server system may include middle tier and back-end computing devices. In some embodiments, a computer server system may be a cluster formed of a plurality of interoperating computing devices.

The server computer system 120 may be an application server and/or a web server. For example, a mobile application may be resident on the client device 110 and may allow the server computer system 120 to communicate with the client device 110. For example, the mobile application may present one or more graphical user interfaces on a display screen of the client device 110 that may allow the server computer system 120 to communicate with the client device 110.

The server computer system 120 may additionally or alternatively be associated with a financial institution and/or a value transfer card issuer. The financial institution and/or the value transfer card issuer may issue value transfer cards. A value transfer card may include a payment card such as for example a credit card. The value transfer card may be associated with a unique identifier such as for example a primary account number (PAN), a verification number such as for example a credit card verification (ccv) number, and/or an expiry date. The value transfer card may be used to initiate a transfer of resources.

In one or more embodiments, the server computer system 120 may maintain a database that includes various data records. At least some of the data records may be associated with customer bank accounts and/or credit card accounts. At least some of the data records may track particular resource types and this may be based on transfers of resources initiated using a value transfer card.

The network 130 is a computer network. In some embodiments, the network 130 may be an internetwork such as may be formed of one or more interconnected computer networks. For example, the network 130 may be or may include an Ethernet network, an asynchronous transfer mode (ATM) network, a wireless network, a telecommunications network, or the like.

To facilitate a transfer of resources, the system 100 may additionally include one or more third party server computer systems. For example, as shown in FIG. 1, the system 100 may include a transfer rail server 140. The transfer rail server 140 may be referred to as a payment rail server and may communicate with one or more resource transfer initiation systems such as for example a point-of-sale (POS) terminal to facilitate transfers of resources. By way of example, the transfer rail server 140 may be a Visa™, Mastercard™, or American Express™ server. The transfer rail server 140 may facilitate transfers of resources for a particular brand of value transfer card, such as a particular brand of credit card. The transfer rail server 140 may also, in at least some embodiments, be referred to as a credit card network server.

To process a transfer of resources, a POS terminal or other transfer initiation system may communicate with the transfer rail server 140. For example, the transfer initiation system may send, to the transfer rail server 140, a resource transfer request. The resource transfer request may specify, for example, an amount of resources to be transferred. The resource transfer request may also include or be associated with one or more credentials associated with a value transfer card. The credentials may include, for example, a unique identifier of the value transfer card such as for example the PAN, the expiry date, and/or cvv number of the value transfer card. Other metadata may also be included in the transfer request such as, for example, a merchant identifier, location information specifying a location at which the transfer initiation system purports to be located, and/or other information.

After the transfer rail server 140 receives a resource transfer request, it may communicate a computer-readable message to the server computer system 120 that includes a unique identifier and a request to transfer an amount of resources.

The server computer system 120 may perform operations to approve or complete the transfer of the amount of resources. The transfer rail server 140 receives a response from the server computer system 120 indicating approval or completion of the transfer request and may communicate a corresponding message to the transfer initiation system.

It will be appreciated that the client device 110 may include a stored representation of the value transfer card. For example, a token may be stored in secure memory of the client device 110 to allow the client device 110 to be used in initiating a transaction, such as a transfer of resources. For example, the client device may include a near field communication (NFC) subsystem which may be used to send a token to the transfer initiation system in order to initiate or complete a transfer of resources.

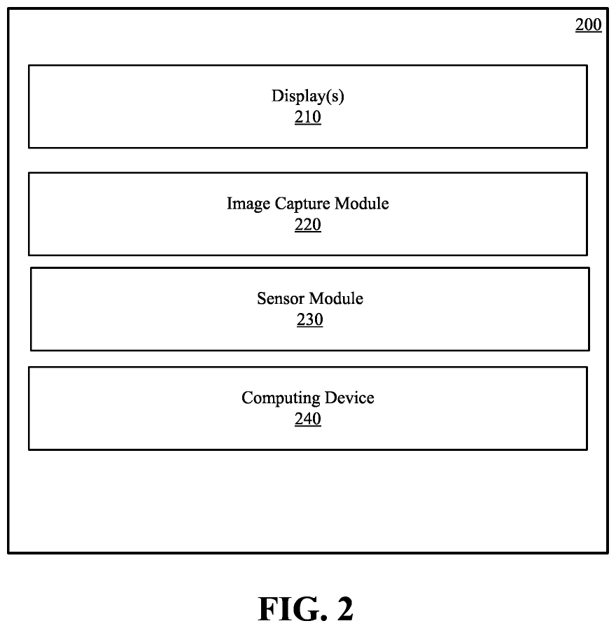

FIG. 2 is a simplified schematic diagram showing components of an exemplary computing device 200. The client device 110 may be of the same type as computing device 200. The computing device 200 may include modules including, as illustrated, for example, one or more displays 210, an image capture module 220, a sensor module 230, and a computer device 240.

The one or more displays 210 are a display module. The one or more displays 210 are used to display screens of a graphical user interface that may be used, for example, to communicate with the server computer system 120 (FIG. 1). The one or more displays 210 may be internal displays of the computing device 200 (e.g., disposed within a body of the computing device).

The image capture module 220 may be or may include a camera. The image capture module 220 may be used to obtain image data, such as images. The image capture module 220 may be or may include a digital image sensor system as, for example, a charge coupled device (CCD) or a complementary metal-oxide-semiconductor (CMOS) image sensor.

The sensor module 230 may be a sensor that generates sensor data based on a sensed condition. By way of example, the sensor module 230 may be or include a location subsystem which generates geolocation data indicating a location of the computing device 200. The location may be the current geographic location of the computing device 200. The location subsystem may be or include any one or more of a global positioning system (GPS), an inertial navigation system (INS), a wireless (e.g., cellular) triangulation system, a beacon-based location system (such as a Bluetooth low energy beacon system), or a location subsystem of another type.

The computer device 240 is in communication with the one or more displays 210, the image capture module 220, and the sensor module 230. The computer device 240 may be or may include a processor which is coupled to the one or more displays 210, the image capture module 220, and/or the sensor module 230.

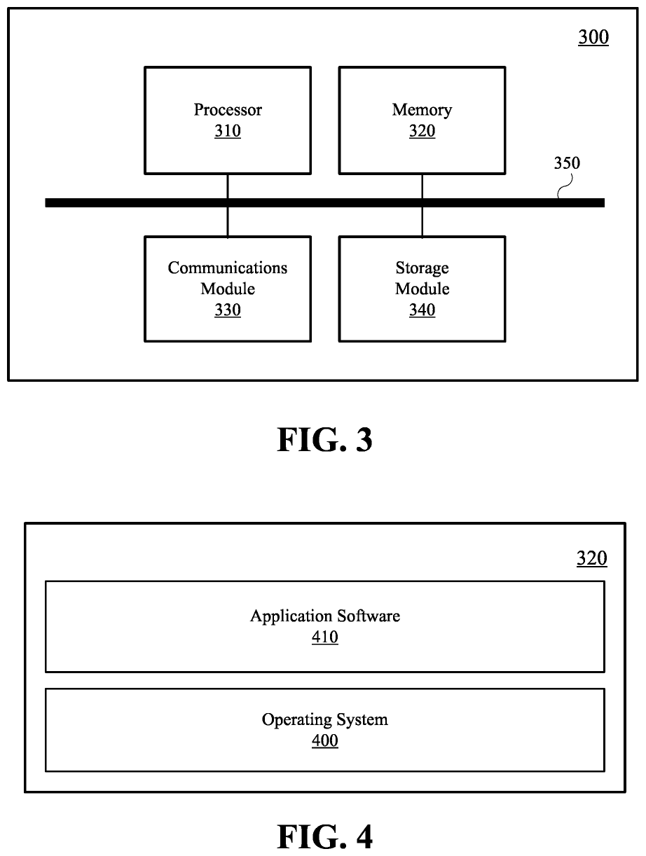

Referring now to FIG. 3, a high-level operation diagram of an example computer device 300 is shown. In some embodiments, the computer device 300 may be exemplary of the computer device 240 (FIG. 2), the server computer system 120 and/or the transfer rail server 140.

The example computer device 300 includes a variety of modules. For example, as illustrated, the example computer device 300 may include a processor 310, a memory 320, a communications module 330, and/or a storage module 340. As illustrated, the foregoing example modules of the example computer device 300 are in communication over a bus 350.

The processor 310 is a hardware processor. The processor 310 may, for example, be one or more ARM, Intel x86, PowerPC processors or the like.

The memory 320 allows data to be stored and retrieved. The memory 320 may include, for example, random access memory, read-only memory, and persistent storage. Persistent storage may be, for example, flash memory, a solid-state drive or the like. Read-only memory and persistent storage are non-transitory computer-readable storage mediums. A computer-readable medium may be organized using a file system such as may be administered by an operating system governing overall operation of the example computer device 300.

The communications module 330 allows the example computer device 300 to communicate with other computer or computing devices and/or various communications networks. For example, the communications module 330 may allow the example computer device 300 to send or receive communications signals. Communications signals may be sent or received according to one or more protocols or according to one or more standards. For example, the communications module 330 may allow the example computer device 300 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 330 may allow the example computer device 300 to communicate using near-field communication (NFC), via Wi-Fi™, using Bluetooth™ or via some combination of one or more networks or protocols. In some embodiments, all or a portion of the communications module 330 may be integrated into a component of the example computer device 300. For example, the communications module may be integrated into a communications chipset. In some embodiments, the communications module 330 may be omitted such as, for example, if sending and receiving communications is not required in a particular application.

The storage module 340 allows the example computer device 300 to store and retrieve data. In some embodiments, the storage module 340 may be formed as a part of the memory 320 and/or may be used to access all or a portion of the memory 320. Additionally or alternatively, the storage module 340 may be used to store and retrieve data from persisted storage other than the persisted storage (if any) accessible via the memory 320. In some embodiments, the storage module 340 may be used to store and retrieve data in a database. A database may be stored in persisted storage. Additionally or alternatively, the storage module 340 may access data stored remotely such as, for example, as may be accessed using a local area network (LAN), wide area network (WAN), personal area network (PAN), and/or a storage area network (SAN). In some embodiments, the storage module 340 may access data stored remotely using the communications module 330. In some embodiments, the storage module 340 may be omitted and its function may be performed by the memory 320 and/or by the processor 310 in concert with the communications module 330 such as, for example, if data is stored remotely. The storage module may also be referred to as a data store.

Software comprising instructions is executed by the processor 310 from a computer-readable medium. For example, software may be loaded into random-access memory from persistent storage of the memory 320. Additionally or alternatively, instructions may be executed by the processor 310 directly from read-only memory of the memory 320.

FIG. 4 depicts a simplified organization of software components stored in the memory 320 of the example computer device 300 (FIG. 3). As illustrated, these software components include an operating system 400 and an application 410.

The operating system 400 is software. The operating system 400 allows the application 410 to access the processor 310 (FIG. 3), the memory 320, and the communications module 330 of the example computer device 300 (FIG. 3). The operating system 400 may be, for example, Google™ Android™, Apple™ iOS™, UNIX™, Linux™, Microsoft™ Windows™, Apple OSX™ or the like.

The application 410 adapts the example computer device 300, in combination with the operating system 400, to operate as a device performing a particular function. For example, the application 410 may cooperate with the operating system 400 to adapt a suitable embodiment of the example computer device 300 to operate as the computer device 240 (FIG. 2), the server computer system 120 and/or the transfer rail server 140.

While a single application 410 is illustrated in FIG. 3, in operation the memory 320 may include more than one application 410 and different applications 410 may perform different operations. For example, in at least some embodiments in which the computer device 300 is functioning as the client device 110, the applications 410 may include a computer resource tracking application. The computer resource tracking application may be configured for secure communications with the server computer system 120 and may be used to track usage of one or more computer resources. As will be described in more detail below, the computer resource tracking application may allow a user to initiate a request to configure a unique identifier.

By way of further example, in at least some embodiments in which the computer device 300 is functioning as the client device 110, the applications 410 may include a banking application. The banking application may be configured for secure communications with the server computer system 120 and may provide various banking functions such as, for example, the ability to display a quantum of value in one or more transfer records (e.g. display balances), configure transfers of data (e.g. bill payments and other transfers), and account management functions. As will be described in more detail below, the mobile banking application may allow a user to initiate a request to configure a unique identifier.

By way of further example, in at least some embodiments in which the computer device 300 functions as the client device 110, the applications 410 may include a web browser, which may also be referred to as an Internet browser. In at least some such embodiments, the server computer system 120 may be a web server that may serve one or more of the graphical user interfaces described herein. The web server may cooperate with the web browser and may serve as an interface when the interface is requested through the web browser. For example, the web browser may serve as a mobile or online banking interface. The mobile banking interface may provide various banking functions such as, for example, the ability to display a quantum of value in one or more transfer records (e.g. display balances), configure transfers of data (e.g. bill payments and other transfers), and account management functions. As will be described in more detail below, the mobile banking interface may allow a user to initiate a request to configure a unique identifier.

In one or more embodiments, the client device 110 may initiate communication with the server computer system 120 when the mobile application is opened on the client device 110 and/or when the mobile interface is opened within a web browser executing on the client device 110. In response, the server computer system 120 may present one or more graphical user interfaces on a display screen of the client device 110. The one or more graphical user interfaces may include one or more selectable interface elements that may be selected by a user of the client device 110 by, for example, performing a tap gesture at a location of the one or more selectable interface elements. It will be appreciated that other types of interface elements may be presented such as for example interface elements that include an input field allowing the user to input and submit text to the server computer system 120.

Within the mobile application and/or mobile interface, the user of the client device 110 may submit a request to configure a unique identifier. In one or more embodiments, the request to configure the unique identifier may be included with a request to track multiple computer resources. In one or more embodiments, the request to configure the unique identifier may be included with a request for a new credit card account and/or may be included with a request to modify parameters of an existing credit card account. In response, the server computer system 120 may present one or more graphical user interfaces on the display screen of the client device 110. The one or more graphical user interfaces may include a request for information required to complete a credit card application form. The information may include information required to fulfill know your customer (KYC) requirements.

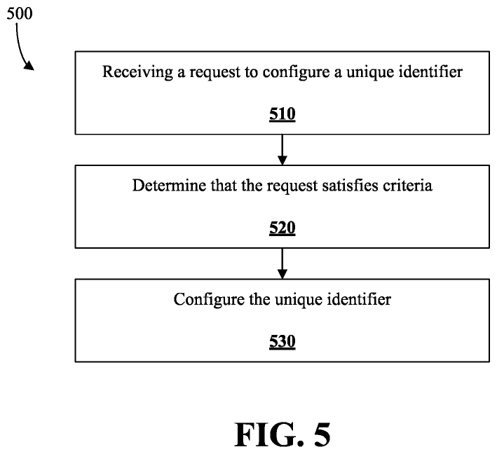

The server computer system 120 may perform operations to determine that the request to configure the unique identifier satisfies criteria. Reference is made to FIG. 5, which illustrates, in flowchart form, a method 500 for determining that a request satisfies criteria. The method 500 may be implemented by a computing device having suitable processor-executable instructions for causing the computing device to carry out the described operations. The method 500 may be implemented, in whole or in part, by the server computer system 120.

The method 500 includes receiving a request to configure a unique identifier (step 510).

In one or more embodiments, the request may be received from the client device 110. For example, a user of the client device 110 may submit the request and in response the client device 110 may communicate the request to the server computer system 120.

In one or more embodiments, the request to configure the unique identifier may be included with a request to track multiple computer resources. For example, the request may include a request to track at least a first computer resource type and a second compute resource type using a unique identifier.

In one or more embodiments, the request to configure the unique identifier may be included with a request to open a new credit card account. The request to open the new credit card account may include customer data that may be required to fulfill KYC requirements. The customer data may include a name, address, social security number, etc.

The request to configure the unique identifier may include a request to open a multicurrency credit card account. For example, the request may include a request to open a credit card account that may be used in at least a first currency and a second currency without having to convert the first and second currency to a default currency.

In one or more embodiments, the request may identify one or more data records or bank accounts that are associated with a user of the client device 110. For example, prior to sending the request, the client device 110 may be authenticated by the server computer system 120 and this may be done, for example, by prompting the user of the client device 110 to enter a username and a password. Responsive to successful authentication of the client device 110, the server computer system 120 may identify one or more customer bank accounts associated with the user. For example, the server computer system 120 may consult a database using the authentication information and may retrieve or otherwise obtain data associated with one or more customer bank accounts. The data may identify at least a type of the bank account, a currency of the bank account, a balance of the bank account, etc.

The method 500 includes determining that the request satisfies criteria (step 520).

In one or more embodiments, the request to configure the unique identifier may be included with a request to track multiple computer resources. In these embodiments, the criteria may include determining that the user has sufficient permissions to track or access the multiple computer resources. The server computer system 120 may determine that the request satisfied criteria by consulting a database used to maintain permissions of computer resources to ensure that the user indeed has access to the computer resources.

In one or more embodiments, the request to configure the unique identifier may be included with a request to open a multicurrency credit card account. In these embodiments, the criteria may include a requirement that the user has at least a third data record storing a first resource type and a fourth data record storing a second resource type. In one example, the third data record storing the first resource type may include a first bank account and the first resource type may include a first currency. The fourth data record storing the second resource type may include a second bank account and the second resource type may include a second currency. In this example, the multicurrency credit card account may include a credit card account that may be used to automatically complete transactions in the first currency and the second currency without having to convert the first currency and the second currency to a default currency.

Responsive to determining that the request satisfies criteria, the method 500 includes configuring the unique identifier (step 530).

When it is determined that the request to configure the unique identifier satisfies the criteria, the server computer system 120 configures the unique identifier.

In one or more embodiments, the server computer system 120 may engage a random number generator to generate the unique identifier. For example, where the request to configure the unique identifier includes a request to track multiple computer resources, the server computer system 120 may send a request to generate a random number for the unique identifier. The request may include parameters for the random number such as a length of the random number, and one or more fixed numbers to be included with the random number.

In one or more embodiments, the server computer system 120 may configure the unique identifier to be in a particular format. For example, where the request to configure the unique identifier includes a request to open a multicurrency credit card account, the unique identifier may be generated as a primary account number (PAN) in accordance with predefined criteria. The predefined criteria may be, for example, criteria set by the International Organization for Standardization (ISO). The predefined criteria may include an identifier of a credit card issuer such as for example Visa™, Mastercard™, or American Express™, etc. followed by an account number.

It will be appreciated that in one or more embodiments the server computer system 120 may engage an application programming interface (API) to request and obtain the unique identifier or may communicate with one or more third party servers to request and obtain the unique identifier.

In one or more embodiments, the unique identifier may be associated with the user or entity that is associated with the first data record and second data record required to satisfy the criteria of step 520 and the association may be stored in a database.

In one or more embodiments, configuring the unique number may include creating or assigning one or more data records to the unique number. For example, in embodiments where the unique identifier is for a multicurrency credit card, the server computer system 120 may create a first data record for tracking a first resource type and a second data record for tracking a second resource type.

In one or more embodiments, responsive to configuring the unique number, the server computer system 120 may perform operations to issue a value transfer card such as for example a credit card associated with the unique number. The value transfer card may be used to initiate transfers at one or more transfer initiation systems. For example, the value transfer card may be used to complete transactions at a POS terminal to purchase goods and/or services.

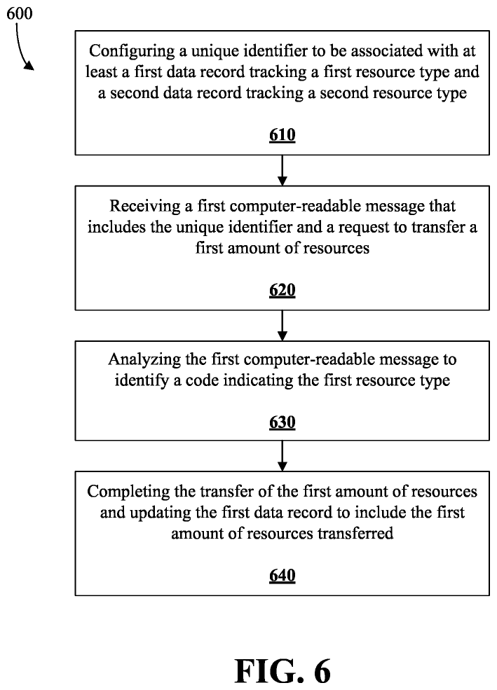

Responsive to configuring the unique identifier, the server computer system 120 may perform operations to track multiple resource types using the unique identifier. Reference is made to FIG. 6, which illustrates, in flowchart form, a method 600 for tracking multiple resource types using the unique identifier. The method 600 may be implemented by a computing device having suitable processor-executable instructions for causing the computing device to carry out the described operations. The method 600 may be implemented, in whole or in part, by the server computer system 120.

The method 600 includes configuring a unique identifier to be associated with at least a first data record tracking a first resource type and a second data record tracking a second resource type (step 610).

The server computer system 120 configures the unique identifier to be associated with at least a first data record tracking a first resource type and a second data record tracking a second resource type.

In one or more embodiments, the unique identifier may be associated with a first data record that is used to track a first computing resource type and a second data record tracking a second, different computing resource type. In these embodiments, the first data record may be used to track usage of the first computing resource type and the second data record may be used to track usage of the second computing resource type.

In one or more embodiments, configuring the unique number may include creating or assigning one or more data records to the unique number. For example, in embodiments where the unique identifier is for a multicurrency credit card, the server computer system 120 may create a first data record for tracking a first resource type and a second data record for tracking a second resource type. In these embodiments, the first data record may be used to track purchases made on the multicurrency credit card in the first currency and the second data record may be used to track purchases made on the multicurrency credit card in the second currency. In this manner, the multicurrency credit card may be used to complete purchases in the first currency and the second currency while eliminating the requirement to convert the first currency and/or the second currency to a default currency.

The method 600 includes receiving a first computer-readable message that includes the unique identifier and a request to transfer a first amount of resources (step 620).

In one or more embodiments, the server computer system 120 may receive a first computer-readable message that includes the unique identifier and a request to transfer a first amount of computing resources to a requesting device. The first computer-readable message may include computer program code that may be received and analyzed by one or more processors of the server computer system 120. The first computer-readable message may be in a format that cannot be read without the use of a computer system such as for example the server computer system 120.

As mentioned, in one or more embodiments, responsive to configuring the unique number, the server computer system 120 may perform operations to issue a value transfer card such as for example a credit card associated with the unique number. The value transfer card may be used to initiate transfers at one or more transfer initiation systems. Responsive to a transaction being initiated, the server computer system 120 may receive, from a transfer initiation system, the first computer-readable message that includes the unique identifier and a request to transfer the first amount of resources.

The method 600 includes analyzing the first computer-readable message to identify a code indicating the first resource type (step 630).

As mentioned, the first computer-readable message may include computer program code that may be analyzed by one or more processors of the server computer system 120. The server computer system 120 analyzes the first computer-readable message, specifically the computer program code, to identify a code that indicates the first resource type.

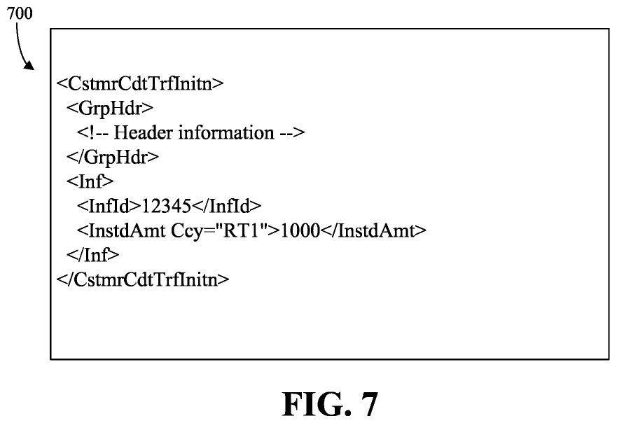

An example first computer-readable message 700 is shown in FIG. 7. In the example shown in FIG. 7, the server computer system 120 may analyze the computer program code to identify a code “RT1” that indicates the first resource type. In this example, the computer program code also includes “1000” which may be identified by the server computer system 120 as being the first amount of the first resource type requested. It will be appreciated that the first computer-readable message 700 may include additional computer program code that may be interpreted by one or more processors of the server computer system 120.

The code may additionally or alternatively be analyzed to identify one or more indications that the resource type includes the first resource type. For example, the code may indicate a name of a merchant who initiated the transfer. In this example, the server computer system 120 may analyze the code to identify the merchant and may perform operations to determine a location of the merchant. The location of the merchant may be used to determine which resource type is to be used for the transfer. As another example, the code may include an identifier of a merchant who initiated the transaction, an internet protocol (IP) address of the transfer initiation system that initiated the transfer, etc. In these examples, the server computer system 120 may extract the code from the computer-readable message and may perform operations to identify the resource type to be used for the transfer.

The method 600 includes completing the transfer of the first amount of resources and updating the first data record to include the first amount of resources transferred (step 640).

Responsive to receiving the first readable message, the server computer system 120 completes the transfer of the first amount of resources. For example, the server computer system 120 may perform operations to transfer the first amount of computer resources to a node of a computer network. As another example, the server computer system 120 may perform operations to complete a transaction using the multicurrency credit card account by initiating a transfer of funds to the merchant associated with the transfer initiation system and this may be done to complete the transaction.

The server computer system 120 updates the first data record to include the first amount of the first resource transferred. In this embodiment, since the code identifies the first resource type, the server computer system 120 updates the first data record that tracks the first resource type. In this manner, the server computer system 120 completes the requested transfer using the first resource type and updates the first data record that is used to track the first resource type. This eliminates the requirement of the server computer system 120 converting the first resource type to a default resource type. Put another way, in this embodiment, a transaction may be completed using the multicurrency credit card in a first currency. The server computer system 120 completes the transaction automatically and without any interaction with the user.

It will be appreciated that a transfer of a second amount of resources of the second resource type may be completed in a similar manner to steps 620 to 640 described herein. For example, the server computer system 120 may receive a second computer-readable message that includes the unique identifier and a request to transfer a second amount of resources and this may be similar to that described herein with reference to step 620. The server computer system 120 may analyze the second computer-readable message to identify a code indicating the second resource type and this may be similar to that described herein with reference to step 630. The server computer system 120 may complete the transfer of the second amount of resources and update the second data record to include the second amount of resources transferred and this may be similar to that described herein with reference to 640. For example, during the step 640, the server computer system 120 updates the second data record to include the second amount of the second resource transferred. In this embodiment, since the code identifies the second resource type, the server computer system 120 updates the second data record that tracks the second resource type. In this manner, the server computer system 120 completes the requested transfer using the second resource type and updates the second data record that is used to track the second resource type. This eliminates the requirement of the server computer system 120 converting the second resource type to a default resource type. Put another way, in this embodiment, a transaction may be completed using the multicurrency credit card in a second currency. The server computer system 120 completes the transaction automatically and without any interaction with the user.

It will be appreciated that a transfer of a third amount of resources of a third resource type may be completed in a similar manner to steps 620 to 640 described herein. For example, the server computer system 120 may receive a third computer-readable message that includes the unique identifier and a request to transfer a third amount of resources and this may be similar to that described herein with reference to step 620. The server computer system 120 may analyze the third computer-readable message to identify a code indicating a third resource type and this may be similar to that described herein with reference to step 630. The server computer system 120 may convert the third amount of resources from the third resource type to a fourth amount of the first resource type. The server computer system 120 may complete the transfer of the third amount of resources and may update the first data record to include the fourth amount of the first resource type and this may be similar to that described herein with reference to 640. In this manner, the multicurrency credit card may be used to complete a transaction using a third currency that may be converted to the first currency.

The server computer system 120 may continue to track multiple resource types using the unique identifier and, responsive to a trigger condition, may generate a statement. For example, the server computer system 120 may determine a trigger condition such as determining an end of a credit card cycle for the multicurrency credit card. In response, the server computer system 120 may generate a statement that includes an amount of the first resource type indicated by the first data record and an amount of the second resource type indicated by the second data record. The statement may be generated in electronic form and/or paper form and may be provided to the user as a credit card statement. In this manner, the user may be provided with a credit card statement that includes an amount owing in the first currency and an amount owing in the second currency. The amount owing in the first currency may be equal to the amount spent on the multicurrency credit card in the first currency. The amount owing in the second currency may be equal to the amount spent on the multicurrency credit card in the second currency. The user is therefore not charged foreign transaction fees as the server computer system 120 maintains separate data records for each currency associated with the multicurrency credit card.

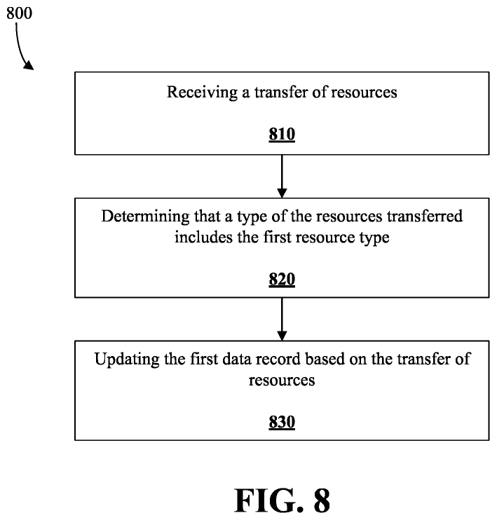

In one or more embodiments, criteria for opening the multicurrency credit card account includes a requirement that the user has a bank account in the first currency and a bank account in the second currency. As such, the user may pay the amount owing in the first currency in the first currency and may pay the amount owing in the second currency in the second currency and this may be done directly without any requirement for foreign transaction fees. The server computer system 120 may automatically apply payments made to the multicurrency credit card account. Reference is made to FIG. 8, which illustrates, in flowchart form, a method 800 for automatically applying a transfer of resources. The method 800 may be implemented by a computing device having suitable processor-executable instructions for causing the computing device to carry out the described operations. The method 800 may be implemented, in whole or in part, by the server computer system 120.

The method 800 includes receiving a transfer of resources (step 810).

The user may transfer resources from the third data record storing the first resource type, for example, and this may be done to pay at least a portion of the amount owing on the multicurrency credit card.

The method 800 includes determining that a type of the resources transferred includes the first resource type (step 820).

The server computer system 120 may analyze the type of the resources transferred to determine that the type of resources includes the first resource type. For example, the server computer system 120 may determine that the resources transferred include resources in the first currency.

The method 800 includes updating the first data record based on the transfer of resources (step 830).

Responsive to determining that the type of resources transferred includes the first resource type, the server computer system 120 updates the first data record based on the transfer of resources. For example, the user may submit an amount of resources in the first currency to pay the portion of the multicurrency credit card bill that is in the first currency and in response the server computer system 120 may apply the payment to the amount owing in the first currency.

It will be appreciated that the method 800 may be performed by the server computer system 120 in a similar manner when it is determined that the type of resources transferred includes the second resource type such that the server computer system 120 updates the second data record. For example, the user may submit an amount of resources in the second currency to pay the portion of the multicurrency credit card bill that is in the second currency and in response the server computer system 120 may apply the payment to the amount owing in the second currency.

In one or more embodiments described herein where the unique identifier is associated with a multicurrency credit card account, by having a requirement that a user have a bank account in a first currency and another bank account in a second currency prior to configuring the unique identifier, and by creating and having separate data records that are used to track the different currencies of the multicurrency credit card account, the server computer system 120 may automatically complete transactions on the multicurrency credit card account in both the first and second currencies. Further, through use of the separate data records, the server computer system 120 is able to track separate balances on the multicurrency credit card for the first currency and the second currency and as such the server computer system 120 is able to generate separate balances for each currency on a credit card statement. The server computer system 120 is able to receive payments in the first currency and the second currency and automatically applies the payments based on what currency is received. For example, when the first currency is sent for payment the server computer system 120 automatically applies the first currency to the portion of the credit card statement that is in the first currency.

In manners described herein, a cardholder who travels from country to country may conveniently and automatically use a multicurrency credit card to complete transactions in at least first and second currencies. Conveniently, purchases made in the first and second currencies are tracked separately such that a credit card statement includes a total amount owing for all purchases made using the first currency and a total amount owing for all purchases made using the second currency. The user may thus send payment from a resource account and the payment will be automatically applied based on what currency the sending resource account is associated with. For example, payment may be received in the first currency and as such the server computer system 120 described herein may automatically apply the payment to the total amount owing for all purchases made using the first currency. As another example, payment may be received in the second currency and as such the server computer system 120 described herein may automatically apply the payment to the total amount owing for all purchases made using the second currency. This provides for a simple and convenient manner for completing purchases on a single credit card having a single unique identifier in multiple countries that operate in multiple currencies while eliminating unnecessary foreign transaction fees and eliminating any requirement for user interaction.

Although in embodiments described herein, a unique identifier is described as being associated with a first data record tracking a first resource type and a second data record tracking a second resource type, it will be appreciated that the unique identifier may be associated with additional data records tracking additional resource types. For example, the unique identifier may be associated with three (3) or four (4) different data records, each of which tracks a different resource type.

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

What is claimed is:

1. A server computer system, comprising:
a communications module;
at least one processor coupled with the communications module; and
a memory coupled to the processor, the memory storing processor-executable instructions that, when executed, configure the at least one processor to:
configure a unique identifier to be associated with at least a first data record tracking a first resource type and a second data record tracking a second resource type;
receive, via the communications module, a first computer-readable message that includes the unique identifier and a request to transfer a first amount of resources;
analyze the first computer-readable message to identify a code indicating the first resource type; and
complete the transfer of the first amount of resources and update the first data record to include the first amount of resources transferred.

2. The server computer system of claim 1, wherein the instructions, when executed, further configure the at least one processor to:
receive, via the communications module, a second computer-readable message that includes the unique identifier and a request to transfer a second amount of resources;
analyze the second computer-readable message to identify a code indicating the second resource type; and
complete the transfer of the second amount of resources and update the second data record to include the second amount of resources transferred.

3. The server computer system of claim 1, wherein the instructions, when executed, further configure the at least one processor to:
receive, via the communications module, a third computer-readable message that includes the unique identifier and a request to transfer a third amount of resources;
analyze the third computer-readable message to identify a code indicating a third resource type;
convert the third amount of resources from the third resource type to a fourth amount of the first resource type; and
complete the transfer of the third amount of resources and update the first data record to include the fourth amount of the first resource type.

4. The server computer system of claim 1, wherein the instructions, when executed, further configure the at least one processor to:
receive, via the communications module, a request to configure the unique identifier.

5. The server computer system of claim 4, wherein the instructions, when executed, further configure the at least one processor to:
prior to configuring the unique identifier, determine that the request satisfies criteria.

6. The server computer system of claim 5, wherein the criteria requires a third data record storing the first resource type and a fourth data record storing the second resource type.

7. The server computer system of claim 6, wherein the unique identifier is associated with a same user as the third data record and the fourth data record.

8. The server computer system of claim 1, wherein the unique identifier includes a primary account number.

9. The server computer system of claim 1, wherein the instructions, when executed, further configure the at least one processor to:
determine a trigger condition; and
responsive to determining the trigger condition, generate a statement that includes an amount of the first resource type indicated by the first data record and an amount of the second resource type indicated by the second data record.

10. The server computer system of claim 9, wherein the instructions, when executed, further configure the at least one processor to:
receive a transfer of resources;
determine that a type of the resources transferred includes the first resource type; and
update the first data record based on the transfer of resources.

11. A computer-implemented method comprising:
configuring a unique identifier to be associated with at least a first data record tracking a first resource type and a second data record tracking a second resource type;
receiving a first computer-readable message that includes the unique identifier and a request to transfer a first amount of resources;
analyzing the first computer-readable message to identify a code indicating the first resource type; and
completing the transfer of the first amount of resources and updating the first data record to include the first amount of resources transferred.

12. The computer-implemented method of claim 11, further comprising:
receiving a second computer-readable message that includes the unique identifier and a request to transfer a second amount of resources;
analyzing the second computer-readable message to identify a code indicating the second resource type; and
completing the transfer of the second amount of resources and updating the second data record to include the second amount of resources transferred.

13. The computer-implemented method of claim 11, further comprising:
receiving a third computer-readable message that includes the unique identifier and a request to transfer a third amount of resources;
analyzing the third computer-readable message to identify a code indicating a third resource type;
converting the third amount of resources from the third resource type to a fourth amount of the first resource type; and
completing the transfer of the third amount of resources and updating the first data record to include the fourth amount of the first resource type.

14. The computer-implemented method of claim 11, further comprising:
receiving a request to configure the unique identifier.

15. The computer-implemented method of claim 14, further comprising:
prior to configuring the unique identifier, determining that the request satisfies criteria.

16. The computer-implemented method of claim 15, wherein the criteria requires a third data record storing the first resource type and a fourth data record storing the second resource type.

17. The computer-implemented method of claim 16, wherein the unique identifier is associated with a same user as the third data record and the fourth data record.

18. The computer-implemented method of claim 11, wherein the unique identifier includes a primary account number.

19. The computer-implemented method of claim 11, further comprising:
determining a trigger condition; and
responsive to determining the trigger condition, generating a statement that includes an amount of the first resource type indicated by the first data record and an amount of the second resource type indicated by the second data record.

20. At least one non-transitory computer readable storage medium comprising processor-executable instructions which, when executed, configure at least one processor to:
configure a unique identifier to be associated with at least a first data record tracking a first resource type and a second data record tracking a second resource type;
receive a first computer-readable message that includes the unique identifier and a request to transfer a first amount of resources;
analyze the first computer-readable message to identify a code indicating the first resource type; and
complete the transfer of the first amount of resources and update the first data record to include the first amount of resources transferred.
